(19) United States
(12) Patent Application Publication
(10) Pub. No.: US 2026/0120229 A1
(43) Pub. Date: Apr. 30, 2026

(54) COMPOSITE IMAGE GENERATION OPTIMIZED FOR GUEST CONTEXT STARTUP

(71) Applicant: Microsoft Technology Licensing, LLC, Redmond, WA (US)

(72) Inventors: Frederick Justus SMITH, Coeur D Alene, ID (US); Shaheed Gulamabbas Chagani, Redmond, WA (US); Paul McAlpin Bozzay, Littleton, CO (US); Xuhao HE, Sammamish, WA (US); Aparajita Dutta, Redmond, WA (US)

(21) Appl. No.: 18/933,311

(22) Filed: Oct. 31, 2024

(51) Int. Cl. G06T 1/60

(52) U.S. Cl. CPC G06T 1/60

(57) ABSTRACT

A method executed by a computer system with a processor system involves analyzing read profiling data associated with a first filesystem image to determine the sequence in which a guest context accessed multiple files during its startup. Subsequently, a second filesystem image is created based on this profiling data, comprising various data block sets, each set representing files accessed by the guest context. The data block sets are arranged in the second filesystem image according to the order in which the guest context accessed the corresponding files, ensuring a sequential writing process. This innovative approach optimizes filesystem organization and retrieval efficiency based on actual usage patterns during system initialization.

### BACKGROUND

It is common for modern computer systems to create different guest compute environments (also referred to as “guest environments” or “guest contexts”) using isolation technologies. In general, isolation refers to the ability of a computer system to provide guest contexts in which one or more processes or even an entire operating system (OS) run in relative isolation. For instance, OS-level virtualization technologies refer to isolation techniques in which guest contexts are isolated user-space instances created by a host OS kernel and in which user-space processes run on top of that kernel in isolation from other guest contexts created by the same kernel. Examples of OS-level virtualization technologies include containers (DOCKER), Zones (SOLARIS), and jails (FREEBSD). Hypervisor-based virtualization technologies refer to isolation techniques in which guest contexts are virtual hardware machines (virtual machines, or VMs) created by a host OS that includes a hypervisor and in which an entire additional OS can run in isolation from other VMs. Examples of hypervisor-based virtualization technologies include HYPER-V (MICROSOFT), XEN (LINUX), VMWARE, VIRTUALBOX (ORACLE), and BHYVE (FREEBSD). A host system is a computer system that creates and manages guest contexts, such as containers (e.g., a “container host system” or “container host”) or VMs (e.g., a “VM host system” or “VM host”). Some host systems may combine the OS-level and hypervisor-based virtualization technologies, e.g., by running a container within a lightweight VM.

Regardless of the isolation technology used, a guest context generally needs access to a filesystem volume, such as a filesystem volume comprising files for an OS, files for applications, etc. As such, various disk and/or filesystem “image” formats are employed by various isolation techniques, each with benefits and drawbacks. One commonly used filesystem image format is the tarball (TAR) format, a compressed archive of files and/or directories. A TAR is a single file that contains the contents and metadata of one or more other files and/or directories. The TAR format preserves file permissions, ownership, timestamps, symbolic links, and hard links. The TAR format can be compressed using various compression algorithms, such as gzip, bzip2, xz, and zstd. The TAR format can create a filesystem image containing the files and directories required for a guest context.

The subject matter claimed herein is not limited to embodiments that solve any disadvantages or that operate only in environments such as those described supra. Instead, this background is only provided to illustrate one example technology area where some embodiments described herein may be practiced.

### SUMMARY

In some aspects, the techniques described herein relate to methods, systems, and computer program products, including: identifying read profiling data that corresponds to a first filesystem image, the read profiling data indicating an order in which a guest context accessed a plurality of files within the first filesystem image during a startup of the guest context; and generating a second filesystem image based on the read profiling data, including: identifying a plurality of data block sets, each data block set including one or more data blocks and corresponding to a different file in the plurality of files within the first filesystem image accessed by the guest context during the startup of the guest context; identifying an ordering of the plurality of data block sets, the ordering corresponding to the order in which the guest context accessed each corresponding file during the startup of the guest context; and sequentially writing each data block set into the second filesystem image using the ordering of the plurality of data block sets.

In some aspects, the techniques described herein relate to methods, systems, and computer program products, including: generating read profiling data that corresponds to a first filesystem image, the read profiling data indicating an order in which a guest context accessed a plurality of files within the first filesystem image during a startup of the guest context; and generating a second filesystem image based on the read profiling data, including: identifying a plurality of data block sets, each data block set including one or more data blocks and corresponding to a different file in the plurality of files within the first filesystem image accessed by the guest context during the startup of the guest context; identifying an ordering of the plurality of data block sets, the ordering corresponding to the order in which the guest context accessed each corresponding file during the startup of the guest context; and sequentially write each data block set into the second filesystem image using the ordering of the plurality of data block sets.

In some aspects, the techniques described herein relate to methods, systems, and computer program products, including: generating read profiling data that corresponds to a first filesystem image, including: initiating a startup of a guest context; intercepting a plurality of read input/output (I/O) requests generated by the guest context during the startup of the guest context; for each read I/O request, identifying a corresponding file within the first filesystem image to which the read I/O request corresponds; and identifying an order in which the guest context accessed a plurality of files within the first filesystem image during the startup of the guest context based on identifying the corresponding file within the first filesystem image to which each read I/O request corresponds; and generating a second filesystem image based on the read profiling data, including: identifying a plurality of data block sets, each data block set including one or more data blocks and corresponding to a different file in the plurality of files within the first filesystem image accessed by the guest context during the startup of the guest context; identifying an ordering of the plurality of data block sets, the ordering corresponding to the order in which the guest context accessed each corresponding file during the startup of the guest context; and sequentially write each data block set into the second filesystem image using the ordering of the plurality of data block sets.

This Summary introduces a selection of concepts in a simplified form that are further described below in the Detailed Description. This Summary is not intended to identify key features or essential features of the claimed subject matter, nor is it intended to be used to determine the scope of the claimed subject matter.

### BRIEF DESCRIPTION OF THE DRAWINGS

To describe how the advantages of the systems and methods described herein can be obtained, a more particular description of the embodiments briefly described supra is rendered by reference to specific embodiments thereof, which are illustrated in the appended drawings. These drawings depict only typical embodiments of the systems and methods described herein and are not, therefore, to be considered to be limiting in their scope. Systems and methods are described and explained with additional specificity and detail through the use of the accompanying drawings, in which:

FIG. 1 illustrates an example of a computer architecture that facilitates constructing a filesystem image based on telemetry about how a guest context previously consumed the filesystem image;

FIG. 2 illustrates an example of generating a filesystem image optimized for guest context startup;

FIG. 3 illustrates an example of consuming a filesystem image that has been optimized for guest context startup;

FIG. 4 illustrates a flow chart of an example of a method for a second filesystem image optimized for guest context startup based on read profiling data from a first filesystem image;

FIG. 5 illustrates an example of computer architecture that facilitates streaming a filesystem image from an image store to a host system; and

FIG. 6 illustrates an example of pre-fetching when streaming data blocks from a container image.

### DETAILED DESCRIPTION

When starting a guest context, a host system must load, possibly extract, one or more filesystem images for a given guest context before the host system can start that guest context. This process can be slow and inefficient, especially if the filesystem image is large or there is latency in the underlying storage or transport layers. This can lead to a disruptive delay (e.g., many seconds to minutes) when starting a guest context, even if the filesystem image is stored locally at a host system. The delay is even more disruptive (e.g., many minutes) if the filesystem image is stored remotely, e.g., in a centralized image store accessible by several host systems, and needs to be downloaded to the host system before extraction.

Embodiments described herein address the challenge of delayed startups of guest contexts, such as containers and virtual machines (VMs), due to the need to extract and potentially even download a filesystem image before the guest context can be started, with method and systems for constructing filesystem images for guest contexts. The disclosed embodiments are based on observing the sequence in which a guest context typically loads files from a given filesystem image, for instance, while an operating system (OS) boots or a containerized application loads. The disclosed embodiments then rebuild the filesystem image to arrange the data blocks of the filesystem image to correspond to the order in which the filesystem image's files were observed to have been loaded by a guest context. For example, the data blocks for the first file loaded appear first, the data blocks for the second file loaded appear next, and so on. This arrangement enhances the performance of read-ahead caching and pre-fetching mechanisms, as the likelihood of pre-fetching and caching the data that will be subsequently loaded during guest context startup is significantly increased.

The disclosed embodiments apply to locally stored filesystem images as well as to remotely stored images. For locally stored images, embodiments improve the accuracy of filling a cache with likely subsequent reads by a guest context. Furthermore, sequential reads are more efficient for many storage devices than random reads. Hence, the ability to read a filesystem image sequentially (e.g., into a cache) and obtain data that a guest context will imminently need provides significant performance benefits. For remotely stored images, there are benefits to scenarios in which a filesystem image is downloaded in its entirety and scenarios in which a filesystem image is streamed on-demand. For scenarios in which a filesystem image is downloaded in its entirety, the embodiments provide an opportunity to begin a container's startup before the container's filesystem image is entirely downloaded because the data needed for container startup is likely downloaded first. For scenarios in which a filesystem image is streamed on-demand, the embodiments provide an opportunity to pre-fetch the data for likely subsequent reads, reducing the number of requests to a remote image store. The technical advantages of these improvements include reduced boot times and increased flexibility in storing and retrieving filesystem images.

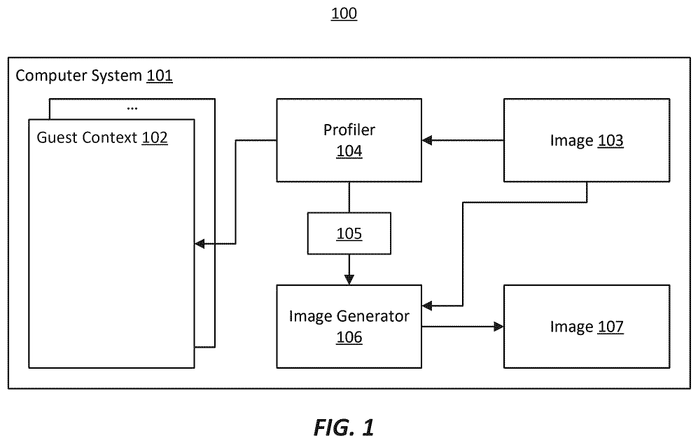

FIG. 1 illustrates an example of a computer architecture 100 that facilitates constructing a filesystem image based on telemetry about how a guest context previously consumed the filesystem image. Computer architecture 100 includes a computer system 101, which includes a processor system (e.g., a single processor or a plurality of processors), a memory (e.g., system or main memory), a storage medium (e.g., a single computer-readable storage medium, or a plurality of computer-readable storage media), and a network interface (e.g., one or more network interface cards) for interconnecting to other computer systems. As shown, computer system 101 hosts a guest context 102, though an ellipsis indicates that computer system 101 can host any number of guest contexts. A guest context 102 can be a container, a VM, or any other type of isolated execution environment that uses a filesystem image 103 to store and access files and data. A filesystem image 103 can be a compressed archive file, such as a tarball or a zip file, containing a hierarchy of files and directories representing a filesystem.

The computer system 101 also includes a file access order profiler (profiler 104), which is a component that monitors and records the read input/output (I/O) requests issued by a guest context 102 during its startup. For example, the profiler 104 can intercept the system calls issued by a guest context 102 to open and read files from the filesystem image 103. The profiler 104 may be implemented as a software module, hardware device, or combination. It may intercept the read I/O requests at various levels of the system stack, such as a hypervisor, a host OS, or a storage driver. The profiler 104 generates read profile data 105 based on the observed read I/O requests, which indicates, or can be used to determine, an order in which the guest context 102 reads files from the filesystem image 103. For instance, the read profile data 105 can be a list of file names or file identifiers, along with information reflecting the order of file access by the guest context 102. In another example, the read profile data 105 may include, for example, a list of files and their corresponding block numbers, offsets, and sizes, or a heatmap of the accessed regions of the filesystem image 103.

An image generator 106 consumes the read profile data 105 to generate a filesystem image 107 optimized for guest context startup. The image generator 106 may be implemented as a software module, hardware device, or combination. It may operate on the same or a different computer system as the profiler 104. In embodiments, the image generator 106 utilizes the read profile data 105 to determine an order in which to arrange data blocks when generating filesystem image 107. In particular, based on read profile data 105, the image generator 106 determines an ordering among at least a subset of files to be written into filesystem image 107. Then when image generator 106 writes data blocks corresponding to those files into filesystem image 107, it sequentially arranges those data blocks to correspond to that determined ordering. Thus, at least a portion of the data blocks within filesystem image 107 are arranged so that a first set of data blocks corresponding to a first file appears first, a second set of data blocks corresponding to a second file appears next, and so on, with the ordering of those files being based on an ordering of files previously read by guest context 102 from filesystem image 103 during its startup. This sequential layout of the data blocks enhances the performance of read-ahead caching and pre-fetching mechanisms, as the likelihood of pre-fetching and caching the data that will be subsequently loaded during guest context startup is significantly increased. Moreover, the filesystem image 107 may reduce the latency and bandwidth requirements for downloading or streaming the filesystem image from a remote source, as the data needed for guest context startup is likely downloaded or streamed first.

In some embodiments, the image generator 106 obtains one or more from filesystem image 103 when generating filesystem image 107, as indicated by an arrow extending from filesystem image 103 to image generator 106. Additionally, or alternatively, the image generator 106 may obtain files from one or more other sources, such as a project build directory. In some situations, the files within filesystem image 107 may correspond precisely to the files within filesystem image 103, with the arrangement of data blocks within filesystem image 107 being optimized for container startup, compared to filesystem image 103. In other situations, the files within filesystem image 107 may differ somewhat from those within filesystem image 103. For example, filesystem image 103 may correspond to an older build or version of an OS or application compared to filesystem image 107. However, even though the identity and/or contents of files within filesystem image 107 may not be identical to those in filesystem image 103, in many situations, the order in which specific files were read by guest context 102 from filesystem image 103 during its startup will generally correspond to the order in which corresponding files (even if their contents are not identical) will be read by another guest context from filesystem image 107 during its startup.

Some embodiments utilize the composite image (CIM) format from MICROSOFT CORPORATION for filesystem image 103 and filesystem image 107. However, other embodiments may use other filesystem image formats, particularly those that separate file data and filesystem metadata. In embodiments, the CIM format is a block-based read-only virtual disk image comprising one or more layers. Each layer contains files and/or directories organized according to a filesystem hierarchy. The layers can be combined (e.g., merged) at runtime to create a unified view of the CIM's filesystem. The layers can be shared among multiple CIMs, reducing storage overhead and improving performance.

In embodiments, a CIM may include a base layer and one or more overlay layers. In some examples, the base layer can provide the core files and directories for the guest context, such as an OS kernel, system libraries, and configuration files. The overlay layer(s) can provide additional files and directories that augment or override the base layer, such as application files, user data, and settings. A CIM also includes metadata that stores information about the structure and content of the CIM, such as the number of layers, the size of each layer, a checksum of each layer, the order of merging the layers, the permissions of each file and directory, and so on. The metadata can be used to validate, mount, and access the files and directories in the CIM.

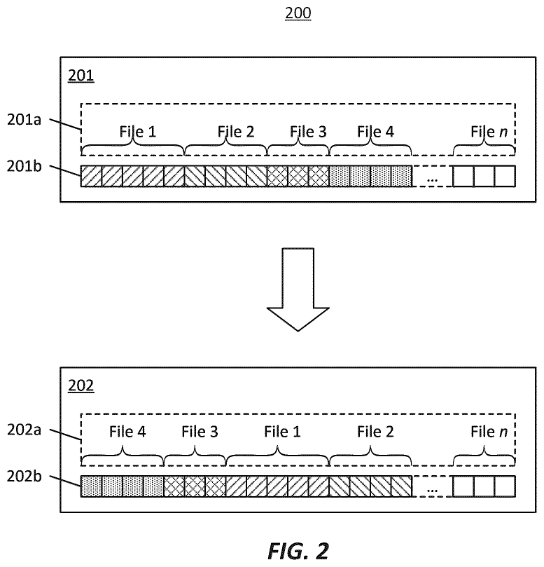

FIG. 2 illustrates an example 200 of generating a filesystem image optimized for guest context startup. In FIG. 2, a filesystem image 201, such as a single-layer CIM, includes a metadata portion 201a and a data portion 201b. The metadata portion 201a describes the filesystem represented by the filesystem image 201, including files and their attributes (e.g., name, size, relevant dates) and a directory hierarchy. The data portion 201b contains the data blocks corresponding to the files described in the metadata portion 201a. For example, as shown, File 1 corresponds to the first five data blocks, File 2 corresponds to the next four data blocks, and so on. Example 200 uses various patterns to indicate which data blocks in data portion 201b correspond to the files described in metadata portion 201a.

In FIG. 2, an arrow indicates a transformation (e.g., by image generator 106) of filesystem image 201 to filesystem image 202, optimized for guest container startup, based on read profile data 105, indicating that the files in filesystem image 201 were accessed in the order of File 4, then File 3, then File 1, then File 2 during a host context startup. Filesystem image 202 similarly includes a metadata portion 202a and a data portion 202b, including the same files contained in filesystem image 201. However, in computer system 101, image generator 106 has re-arranged the data blocks, such that they appear in the order of File 4, then File 3, then File 1, then File 2, consistent with the read profile data 105.

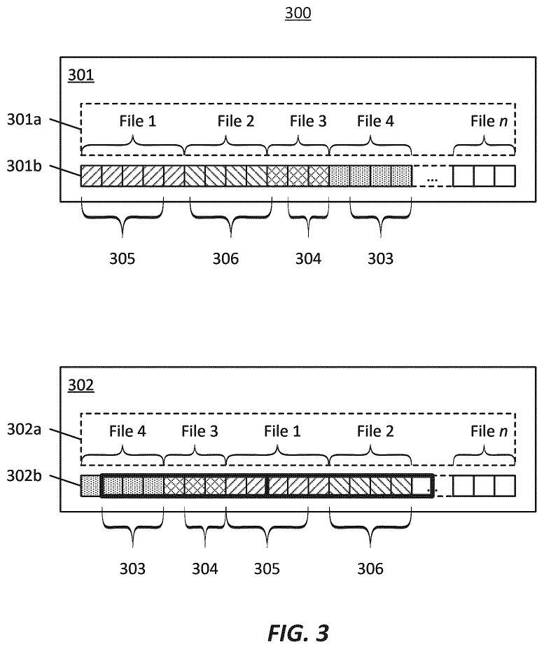

FIG. 3 illustrates an example 300 of consuming a filesystem image optimized for guest context startup. In particular, example 300 includes a filesystem image 301 that mirrors filesystem image 201 of FIG. 2 (e.g., a metadata portion 301a corresponds to metadata portion 201a, and a data portion 301b corresponds to data portion 201b, with the same files and data blocks). Example 300 shows four reads made by a guest context against filesystem image 301, including a first read (data blocks 303) from a portion of File 4, a second read (data blocks 304) from a portion of File 4, a third read (data blocks 305) from a portion of File 1, and a fourth read (data blocks 306) from a portion of File 2.

Example 300 also includes a filesystem image 302 that mirrors the filesystem image 202 of FIG. 2 (e.g., a metadata portion 302a corresponds to metadata portion 202a, and a data portion 302b corresponds to data portion 202b, with the same files and data blocks). Example 300 shows how the same four reads (data blocks 303-306) made by a guest context would map to filesystem image 302. Notably, these reads now follow a pattern of generally sequential access to the data blocks in data portion 302b. However, example 300 uses two boxes with heavy lines (each covering eight data blocks) to show that, rather than fetching the requested data blocks for a given read, some embodiments may pre-fetch some additional data blocks (e.g., a total of eight data blocks for each read, in this example). For example, the first read may fetch the three requested data blocks (data blocks 303) corresponding to File 4, plus five additional data blocks corresponding to the entirety of File 3 and a part of File 1. This means that, when the guest context issues the second read, the requested data blocks (data blocks 304) have already been acquired from filesystem image 302. That read can, therefore, be fulfilled from a cache rather than filesystem image 302. The third read (data blocks 305) may be partially fulfilled from a cache. Still, as shown, when fetching the remaining data blocks from filesystem image 302, some additional data blocks may be fetched as well, meaning that when the fourth read (data blocks 306) is issued by the guest context, that read can be fulfilled from a cache. Thus, in example 300, only two reads of four reads are processed against filesystem image 302, leading to improved read latency.

The amount of pre-fetched data for a given read can vary depending on implementation, and it may be fixed or dynamic. For example, a typical read request may request a set of data blocks, each 512 KB, 4 KB, etc. So, if the length of a read request is eight 512 KB data blocks, the request may be for 4 MB of data. Instead of fetching this amount from filesystem image 302, a storage system may fetch some additional amount, such as a multiple of the requested data or a fixed amount beyond the requested data.

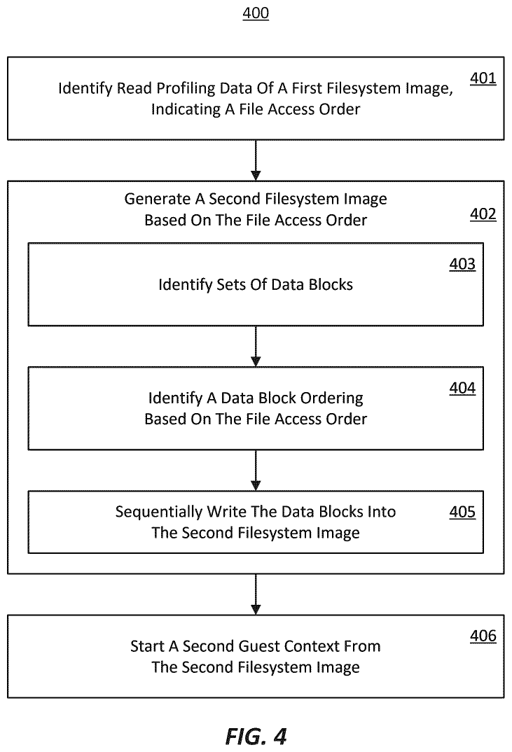

Embodiments are now described in connection with FIG. 4, which illustrates a flow chart of an example method 400 for generating a second filesystem image optimized for guest context startup based on read profiling data from a first filesystem image. In embodiments, instructions for implementing method 400 are encoded as computer-executable instructions (e.g., profiler 104, image generator 106) stored on a computer storage medium that are executable by a processor system to cause a computer system (e.g., computer system 101) to perform method 400.

The following discussion now refers to a method and method acts. Although the method acts are discussed in specific orders or illustrated in a flow chart as occurring in a particular order, no order is required unless expressly stated or required because an act depends on another act being completed before the act being performed.

Referring to FIG. 4, in embodiments, method 400 comprises act 401 of identifying read profiling data of a first filesystem image, indicating a file access order. In some embodiments, act 401 comprises identifying read profiling data that corresponds to a first filesystem image, the read profiling data indicating at least an order in which a guest context accessed a plurality of files within the first filesystem image during a startup of the guest context. For example, referring to FIG. 1, the image generator 106 identifies read profile data 105, generated based on observing the read behaviors of guest context 102 as it starts from filesystem image 103.

In some embodiments, identifying read profiling data of the first filesystem image comprises identifying read profiling data generated by another computer system. In other embodiments, identifying read profiling data of the first filesystem image comprises generating that read profiling data. For example, in some embodiments, act 401 includes initiating the startup of guest context 102. Then using the profiler 104, act 401 includes intercepting a plurality of read I/O requests generated by guest context 102 during the startup of the guest context against filesystem image 103. In some embodiments, the read profile data 105 records these read I/O requests. In other embodiments, the profile data results from analyzing the read I/O requests. For example, for each read I/O request, the profiler 104 or image generator 106 identifies a corresponding file within filesystem image 103 to which the read I/O request corresponds. Then it identifies the order in which the guest context 102 accessed the plurality of files within filesystem image 103 during the startup of the guest context 102, based on identifying the corresponding file within the filesystem image 103 to which each read I/O request corresponds.

Whether the read profiling data is generated locally or remotely, or even a combination of both, in embodiments, it is based on the observed startup of a plurality of guest contexts. Thus, in embodiments, the read profiling data indicates an average order in which a plurality of guest contexts accessed the plurality of files within the first filesystem image during startup.

Method 400 also comprises act 402 of generating a second filesystem image based on the file access order. For example, based on read profile data 105, the image generator 106 generates filesystem image 107. The format of filesystem image 107 can vary. Still, in embodiments, filesystem image 107 is a CIM that stores filesystem metadata and file data separately and potentially a CIM comprising a plurality of filesystem layers. In embodiments, the second filesystem image is a VM disk image or a container image that is suitable for consumption by guest context 102.

As shown, act 402 comprises act 403 of identifying sets of data blocks. In some embodiments, act 403 comprises identifying a plurality of data block sets, each data block set comprising one or more data blocks and corresponding to a different file in the plurality of files within the first filesystem image accessed by the guest context during the startup of the guest context. For example, in reference to FIG. 2, the image generator 106 identifies which blocks in data portion 201b corresponds to File 1, File 2, File 3, and so on.

Act 402 also comprises act 404 of identifying a data block ordering based on the file access order. In some embodiments, act 404 comprises identifying an ordering of the plurality of data block sets, the ordering corresponding to the order in which the guest context accessed each corresponding file during the startup of the guest context. For example, based on read profile data 105, the image generator 106 determines that guest context 102 accessed at least Files 1-4 from data portion 201b in the order of File 4, then File 3, then File 1, then File 2.

Act 402 also comprises act 405 of sequentially writing the data blocks into the second filesystem image. In some embodiments, act 405 comprises sequentially writing each data block set into the second filesystem image using the ordering of the plurality of data block sets. For example, in reference to FIG. 3, the image generator 106 generates data portion 302b by sequentially writing the blocks of Files 1-4 in the order of File 4, then File 3, then File 1, then File 2.

In some embodiments, method 400 also comprises act 406 of starting a second guest context from the second filesystem image. For example, computer system 101, or some other host system, starts a guest context (e.g., guest context 102) based on filesystem image 107. In embodiments, due to the layout of filesystem image 107, the guest context boots with less delay than would be the case if it booted from filesystem image 103. In some embodiments, filesystem image 107 is made available in an image repository, such as image repository 510, described later.

As mentioned, disclosed embodiments apply to locally and remotely stored filesystem images. For locally stored images, embodiments improve the accuracy of filling a cache with likely subsequent reads by a guest context. Furthermore, sequential reads are more efficient for many storage devices than random reads. Hence, the ability to read a filesystem image sequentially (e.g., into a cache) and obtain data that a guest context will imminently need provides significant performance benefits. For remotely stored images, there are benefits to scenarios in which a filesystem image is downloaded in its entirety and scenarios in which a filesystem image is streamed on-demand. For scenarios in which a filesystem image is downloaded in its entirety, the embodiments provide an opportunity to begin a container's startup before the container's filesystem image is entirely downloaded because the data needed for container startup is likely downloaded first. For scenarios in which a filesystem image is streamed on-demand, the embodiments provide an opportunity to pre-fetch the data for likely subsequent reads, reducing the number of requests to a remote image store. The technical advantages of these improvements include reduced boot times and increased flexibility in storing and retrieving filesystem images.

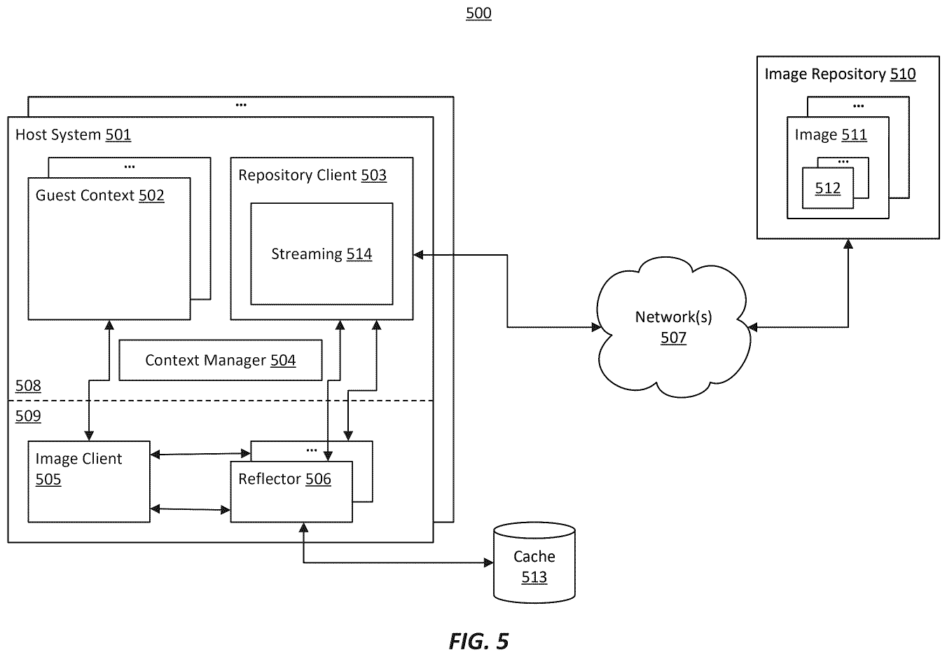

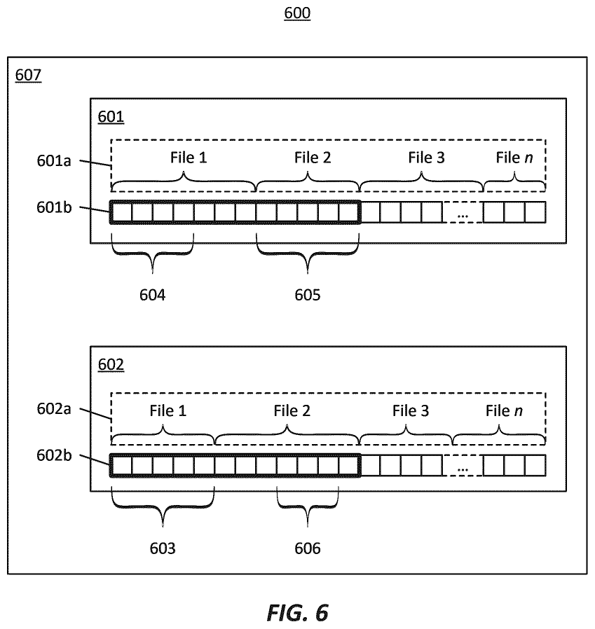

FIG. 5-6 illustrate the benefits of the embodiments described herein within systems where filesystem images are streamed on-demand. FIG. 5 illustrates an example of computer architecture 500 that facilitates streaming a filesystem image from an image store to a host system. Computer architecture 500 includes at least one host computer system (e.g., host system 501) and an image repository computer system (image repository 510). As shown with an ellipsis, the computer architecture 500 may include a plurality of host systems, and the embodiments of the host system 501 described each applicable to each host system. Each host system is connected to the image repository 510 via network(s) 507. Each computer system shown in FIG. 1 includes a processor system (e.g., a single processor or a plurality of processors), a memory (e.g., system or main memory), a storage medium (e.g., a single computer-readable storage medium, or a plurality of computer-readable storage media), and a network interface (e.g., one or more network interface cards) for interconnecting (e.g., network(s) 507) to other computer systems.

In embodiments, each host system, including host system 501, hosts one or more guest compute environments, such as containers and/or VMs. Thus, host system 501 is illustrated as including a context manager 504 (e.g., a container daemon, a hypervisor, a virtualization stack) and a guest context 502 managed by the context manager 504. An ellipsis associated with guest context 502 indicates that host system 501 can host any number of guest contexts, including container(s), VM(s), and/or a combination of containers and VMs.

Each guest context needs access to one or more filesystem images for its operation. For example, as a container, the guest context 502 may need access to application files and data that support the container's operation. As a VM, the guest context 502 may need access to OS files, application files, and data that support the VM's operation. In computer architecture 500, the host system 501 obtains needed filesystem images from the image repository 510 via network(s) 507. For example, image repository 510 is illustrated as including a filesystem image (image 511). An ellipsis associated with image 511 indicates that image repository 510 can store any number of filesystem images. For example, the image repository 510 may store images associated with different OS types (e.g., WINDOWS, LINUX, FREEBSD), with different OS versions and configurations, with different containerized applications, and the like. In some embodiments, the image repository 510 stores generic public images that can be utilized by various customers/tenants. Additionally, or alternatively, the image repository 510 may store specialized private images that are utilized by specific customers/tenants. In some embodiments, the image repository 510 stores filesystem images using the CIM format. Filesystem images may be multi-layer, as indicated by layers 512 in image 511

Currently, host systems download and extract an entire filesystem image, such as a tarball, before their context managers can start a guest context that relies on the entire filesystem image. This can lead to a significant, often many-minute, lag in starting guest contexts. In computer architecture 500, however, the host system 501 steams the contents of needed filesystem images on-demand, enabling context manager 504 to initiate the startup of guest context 502, often even before host system 501 has obtained any file data blocks from image repository 510. For example, the host system 501 is illustrated as including a repository client 503 (e.g., a client of image repository 510) that includes a streaming component 514 that is capable of requesting specific sets of data blocks from filesystem images stored in image repository 510, rather than requesting the filesystem images in their entireties.

In embodiments, the on-demand streaming of filesystem images is enabled by reflector disks, such as reflector disk 506. In embodiments, a reflector disk is a software component that receives read I/O requests from a requesting entity, such as image client 505 or guest context 502, and forwards or “reflects” those read I/O requests to repository client 503. Repository client 503 then fetches the appropriate data blocks from a filesystem image (e.g., image 511) stored in image repository 510 and forwards those data blocks to the reflector disk. The reflector disk then returns the data blocks to the requestor. Thus, in embodiments, a reflector disk represents data blocks of a filesystem image to a requestor without actually containing the data blocks of the filesystem image.

In embodiments, reflector disks operate in connection with filesystem images that store file data and filesystem metadata separately. For example, when context manager 504 requests image 511 from repository client 503 for supporting guest context 502, streaming component 514 initially fetches the filesystem metadata of image 511 from image repository 510. This filesystem metadata provides information about the filesystem represented by image 511, such as files and associated attributes (e.g., names, permissions, size, creation times), a directory structure, volume information (if applicable), and the like. Based on this filesystem metadata, a requestor can identify requested files and initiate read I/O request(s) to reflector disk(s).

In some embodiments, image client 505 consumes the filesystem metadata, presenting it to the guest context 502, and image client 505 is the requestor that initiates I/O request(s) to the reflector disk 506. In other embodiments, the guest context 502 consumes the filesystem metadata directly, and the guest context 502 is the requestor that initiates I/O request(s) to the reflector disk 506. The host system 501 may lack image client 505 in these latter embodiments.

In embodiments, the host system 501 creates a different set of one or more reflector disks for each guest context. In some embodiments, the host system 501 creates a different instance of image client 505 for each guest context, but other embodiments could use a single instance of image client 505 for more than one guest context. In embodiments, when using multi-layer filesystem images, such as CIMs, the host system 501 creates a different reflector disk for each layer of the filesystem image. In these embodiments, a given reflector disk directs read I/O requests to its corresponding layer of the filesystem image. In embodiments that include the image client 505, the image client 505 assembles and merges information received from the various reflector disks, based on the filesystem image metadata. In embodiments that lack the image client 505, the guest context 502 assembles and merges information received from the various reflector disks, based on the filesystem image metadata.

In embodiments, the reflector disks write received data blocks locally to cache 513. Then, if the reflector disks receive a subsequent read I/O request that includes data blocks stored in cache 513, the reflector disk can serve those data blocks from cache 513 rather than streaming them from the image repository 510. In some embodiments, several reflector disks cache data blocks to a single cache. In other embodiments, each reflector disk has a corresponding cache. For instance, each reflector disk could utilize a different cache file, database, or cache data volume.

Within the context of computer architecture 500, FIG. 6 illustrates an example 600 of pre-fetching when streaming data blocks from a container image. Example 600 includes a filesystem image 607 with a plurality of layers, including layer 601 and layer 602. In some examples, filesystem image 607 is a multi-layer CIM. Similar to examples 200 and 300, each layer in a filesystem image 607 includes a metadata portion (e.g., metadata portion 601a and metadata portion 602a) and a data portion (e.g., data portion 601b and data portion 602b). In embodiments similar to data portion 202b and data portion 302b, data portion 601b and data portion 602b in filesystem image 607 have each been optimized by image generator 106 to include a sequential layout of data blocks that are based on the order in which the files contained within filesystem image 607 are anticipated to be accessed by a guest context during startup.

In example 600, streaming component 514 requests more than the requested data blocks for a given read request. For example, based on a first read request for data blocks 603, streaming component 514 requests additional data blocks that exceed the requested amount, as indicated by a heavy box covering the data blocks of both File 1 and File 2 in layer 602. Additionally, based on a second read request for data blocks 604, streaming component 514 requests additional data blocks that exceed the requested amount, as indicated by a heavy box covering the data blocks of both File 1 and File 2 in layer 601. This means that all the data blocks covered by those heavy boxes are cached at cache 513 after the first and second read requests. As a result, when the guest context 502 issues third and fourth read requests, the requested data blocks (e.g., data blocks 605 and 606, respectively) can be served from cache 513 rather than needing to be streamed from the image repository 510.

Notably, pre-fetching data likely to be requested in subsequent read requests can lead to decreased read latency and decreased processor utilization at host system 501, particularly for frequent patterns of sequential reads. For example, in host system 501, reflector disk 506 operates in kernel mode 509, while repository client 503 operates in user mode 508. A time and processing penalty occurs when transitioning between user and kernel mode, as certain processor states (e.g., registers, caches) may need to be saved, restored, or even flushed at each transition. By avoiding streaming some read requests based on pre-fetching, these costly transitions between user and kernel modes are avoided. Further, avoiding streaming some read requests based on pre-fetching also avoids network hops from host system 501 to image repository 510, decreasing latency further and reducing network congestion.

Alternatively or in addition to the other examples described herein, examples include any combination of the following:
Clause 1. A method implemented in a computer system that includes a processor system, comprising: identifying read profiling data that corresponds to a first filesystem image, the read profiling data indicating at least an order in which a guest context accessed a plurality of files within the first filesystem image during a startup of the guest context; and generating a second filesystem image based on the read profiling data, including: identifying a plurality of data block sets, each data block set comprising one or more data blocks and corresponding to a different file in the plurality of files within the first filesystem image accessed by the guest context during the startup of the guest context; identifying an ordering of the plurality of data block sets, the ordering corresponding to the order in which the guest context accessed each corresponding file during the startup of the guest context; and sequentially writing each data block set into the second filesystem image using the ordering of the plurality of data block sets.
Clause 2. The method of clause 1, wherein the method further comprises generating the read profiling data, including: initiating the startup of the guest context; intercepting a plurality of read input/output (I/O) requests generated by the guest context during the startup of the guest context; for each read I/O request, identifying a corresponding file within the first filesystem image to which the read I/O request corresponds; and identifying the order in which the guest context accessed the plurality of files within the first filesystem image during the startup of the guest context based on identifying the corresponding file within the first filesystem image to which each read I/O request corresponds.
Clause 3. The method of clause 1, wherein the read profiling data is generated at a different computer system.
Clause 4. The method of any one of clause 1 to claim 3, wherein the read profiling data further indicates an average order in which a plurality of guest contexts accessed the plurality of files within the first filesystem image during startup.
Clause 5. The method of any one of clause 1 to claim 4, wherein the second filesystem image is a container image (CIM) that stores filesystem metadata and file data separately.
Clause 6. The method of clause 5, wherein the CIM comprises a plurality of filesystem layers.
Clause 7. The method of any one of clause 1 to claim 6, wherein the second filesystem image is part of a filesystem image repository accessible by a plurality of host systems.
Clause 8. The method of any one of clause 1 to claim 7, wherein the second filesystem image is a virtual machine disk image or a container image.
Clause 9. The method of any one of clause 1 to claim 8, wherein first contents of the first filesystem image differ from second contents of the second filesystem image.
Clause 10. The method of any one of clause 1 to claim 9, wherein the method further comprises starting a second guest context from the second filesystem image.
Clause 11. A computer system, comprising: a processor system; and a computer storage medium that stores computer-executable instructions that are executable by the processor system to at least: generate read profiling data that corresponds to a first filesystem image, the read profiling data indicating at least an order in which a guest context accessed a plurality of files within the first filesystem image during a startup of the guest context; and generate a second filesystem image based on the read profiling data, including: identifying a plurality of data block sets, each data block set comprising one or more data blocks and corresponding to a different file in the plurality of files within the first filesystem image accessed by the guest context during the startup of the guest context; identifying an ordering of the plurality of data block sets, the ordering corresponding to the order in which the guest context accessed each corresponding file during the startup of the guest context; and sequentially write each data block set into the second filesystem image using the ordering of the plurality of data block sets.
Clause 12. The computer system of clause 11, wherein generating the read profiling data, includes: initiating the startup of the guest context; intercepting a plurality of read input/output (I/O) requests generated by the guest context during the startup of the guest context; for each read I/O request, identifying a corresponding file within the first filesystem image to which the read I/O request corresponds; and identifying the order in which the guest context accessed the plurality of files within the first filesystem image during the startup of the guest context based on identifying the corresponding file within the first filesystem image to which each read I/O request corresponds.
Clause 13. The computer system of any one of clause 11 or claim 12, wherein the read profiling data indicates an average order in which a plurality of guest contexts accessed the plurality of files within the first filesystem image during startup.
Clause 14. The computer system of any one of clause 11 to claim 13, wherein the second filesystem image is a container image (CIM) that stores filesystem metadata and file data separately.
Clause 15. The computer system of clause 14, wherein the CIM comprises a plurality of filesystem layers.
Clause 16. The computer system of any one of clause 11 to claim 15, wherein the second filesystem image is part of a filesystem image repository accessible by a plurality of host systems.
Clause 17. The computer system of any one of clause 11 to claim 16, wherein the second filesystem image is a virtual machine disk image or a container image.
Clause 18. The computer system of any one of clause 11 to claim 17, wherein the computer-executable instructions are also executable by the processor system to start a second guest context from the second filesystem image.
Clause 19. A computer storage medium that stores computer-executable instructions that are executable by a processor system to at least: generate read profiling data that corresponds to a first filesystem image, including: initiating a startup of a guest context; intercepting a plurality of read input/output (I/O) requests generated by the guest context during the startup of the guest context; for each read I/O request, identifying a corresponding file within the first filesystem image to which the read I/O request corresponds; and identifying an order in which the guest context accessed a plurality of files within the first filesystem image during the startup of the guest context based on identifying the corresponding file within the first filesystem image to which each read I/O request corresponds; and generate a second filesystem image based on the read profiling data, including: identifying a plurality of data block sets, each data block set comprising one or more data blocks and corresponding to a different file in the plurality of files within the first filesystem image accessed by the guest context during the startup of the guest context; identifying an ordering of the plurality of data block sets, the ordering corresponding to the order in which the guest context accessed each corresponding file during the startup of the guest context; and sequentially write each data block set into the second filesystem image using the ordering of the plurality of data block sets.
Clause 20. The computer storage medium of clause 19, wherein the second filesystem image is a container image (CIM) that stores filesystem metadata and file data separately.

Embodiments of the disclosure comprise or utilize a special-purpose or general-purpose computer system (e.g., computer system 101) that includes computer hardware, such as, for example, a processor system and system memory, as discussed in greater detail below. Embodiments within the scope of the present disclosure also include physical and other computer-readable media for carrying or storing computer-executable instructions and/or data structures. Such computer-readable media can be any available media accessible by a general-purpose or special-purpose computer system. Computer-readable media that store computer-executable instructions and/or data structures are computer storage media. Computer-readable media that carry computer-executable instructions and/or data structures are transmission media. Thus, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which store program code in the form of computer-executable instructions or data structures, which can be accessed and executed by a general-purpose or special-purpose computer system to implement the disclosed functionality.

Transmission media include a network and/or data links that carry program code in the form of computer-executable instructions or data structures that are accessible by a general-purpose or special-purpose computer system. A “network” is defined as a data link that enables the transport of electronic data between computer systems and other electronic devices. When information is transferred or provided over a network or another communications connection (either hardwired, wireless, or a combination thereof) to a computer system, the computer system may view the connection as transmission media. The scope of computer-readable media includes combinations thereof.

Upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module and eventually transferred to computer system RAM and/or less volatile computer storage media at a computer system. Thus, computer storage media can be included in computer system components that also utilize transmission media.

Computer-executable instructions comprise, for example, instructions and data which when executed at a processor system, cause a general-purpose computer system, a special-purpose computer system, or a special-purpose processing device to perform a function or group of functions. In embodiments, computer-executable instructions comprise binaries, intermediate format instructions (e.g., assembly language), or source code. In embodiments, a processor system comprises one or more central processing units (CPUs), one or more graphics processing units (GPUs), one or more neural processing units (NPUs), and the like.

In some embodiments, the disclosed systems and methods are practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. In some embodiments, the disclosed systems and methods are practiced in distributed system environments where different computer systems, which are linked through a network (e.g., by hardwired data links, wireless data links, or by a combination of hardwired and wireless data links), both perform tasks. As such, in a distributed system environment, a computer system may include a plurality of constituent computer systems. Program modules may be located in local and remote memory storage devices in a distributed system environment.

In some embodiments, the disclosed systems and methods are practiced in a cloud computing environment. In some embodiments, cloud computing environments are distributed, although this is not required. When distributed, cloud computing environments may be distributed internally within an organization and/or have components possessed across multiple organizations. In this description and the following claims, “cloud computing” is a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as Software as a Service (SaaS), Platform as a Service (PaaS), Infrastructure as a Service (IaaS), etc. The cloud computing model may also be deployed using different deployment models such as private cloud, community cloud, public cloud, hybrid cloud, etc.

Some embodiments, such as a cloud computing environment, comprise a system with one or more hosts capable of running one or more VMs. During operation, VMs emulate an operational computing system, supporting an OS and perhaps one or more other applications. In some embodiments, each host includes a hypervisor that emulates virtual resources for the VMs using physical resources that are abstracted from the view of the VMs. The hypervisor also provides proper isolation between the VMs. Thus, from the perspective of any given VM, the hypervisor provides the illusion that the VM is interfacing with a physical resource, even though the VM only interfaces with the appearance (e.g., a virtual resource) of a physical resource. Examples of physical resources include processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described supra or the order of the acts described supra. Rather, the described features and acts are disclosed as example forms of implementing the claims.

The present disclosure may be embodied in other specific forms without departing from its essential characteristics. The described embodiments are only illustrative and not restrictive. All changes that come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements. Unless otherwise specified, the terms “set,” “superset,” and “subset” are intended to exclude an empty set, and thus “set” is defined as a non-empty set, “superset” is defined as a non-empty superset, and “subset” is defined as a non-empty subset. Unless otherwise specified, the term “subset” excludes the entirety of its superset (i.e., the superset contains at least one item not included in the subset). Unless otherwise specified, a “superset” can include at least one additional element, and a “subset” can exclude at least one element.

What is claimed:

1. A method implemented in a computer system that includes a processor system, comprising:
identifying read profiling data that corresponds to a first filesystem image, the read profiling data indicating an order in which a guest context accessed a plurality of files within the first filesystem image during a startup of the guest context; and
generating a second filesystem image based on the read profiling data, including:
identifying a plurality of data block sets, each data block set comprising one or more data blocks and corresponding to a different file in the plurality of files within the first filesystem image accessed by the guest context during the startup of the guest context;
identifying an ordering of the plurality of data block sets, the ordering corresponding to the order in which the guest context accessed each corresponding file during the startup of the guest context; and
sequentially writing each data block set into the second filesystem image using the ordering of the plurality of data block sets.

2. The method of claim 1, wherein the method further comprises generating the read profiling data, including:
initiating the startup of the guest context;
intercepting a plurality of read input/output (I/O) requests generated by the guest context during the startup of the guest context;
for each read I/O request, identifying a corresponding file within the first filesystem image to which the read I/O request corresponds; and
identifying the order in which the guest context accessed the plurality of files within the first filesystem image during the startup of the guest context based on identifying the corresponding file within the first filesystem image to which each read I/O request corresponds.

3. The method of claim 1, wherein the read profiling data is generated at a different computer system.

4. The method of claim 1, wherein the read profiling data further indicates an average order in which a plurality of guest contexts accessed the plurality of files within the first filesystem image during startup.

5. The method of claim 1, wherein the second filesystem image is a container image (CIM) that stores filesystem metadata and file data separately.

6. The method of claim 5, wherein the CIM comprises a plurality of filesystem layers.

7. The method of claim 1, wherein the second filesystem image is part of a filesystem image repository accessible by a plurality of host systems.

8. The method of claim 1, wherein the second filesystem image is a virtual machine disk image or a container image.

9. The method of claim 1, wherein first contents of the first filesystem image differ from second contents of the second filesystem image.

10. The method of claim 1, wherein the method further comprises starting a second guest context from the second filesystem image.

11. A computer system, comprising:
a processor system; and
a computer storage medium that stores computer-executable instructions that are executable by the processor system to at least:
generate read profiling data that corresponds to a first filesystem image, the read profiling data indicating an order in which a guest context accessed a plurality of files within the first filesystem image during a startup of the guest context; and
generate a second filesystem image based on the read profiling data, including:
identifying a plurality of data block sets, each data block set comprising one or more data blocks and corresponding to a different file in the plurality of files within the first filesystem image accessed by the guest context during the startup of the guest context;
identifying an ordering of the plurality of data block sets, the ordering corresponding to the order in which the guest context accessed each corresponding file during the startup of the guest context; and
sequentially write each data block set into the second filesystem image using the ordering of the plurality of data block sets.

12. The computer system of claim 11, wherein generating the read profiling data, includes:
initiating the startup of the guest context;
intercepting a plurality of read input/output (I/O) requests generated by the guest context during the startup of the guest context;
for each read I/O request, identifying a corresponding file within the first filesystem image to which the read I/O request corresponds; and
identifying the order in which the guest context accessed the plurality of files within the first filesystem image during the startup of the guest context based on identifying the corresponding file within the first filesystem image to which each read I/O request corresponds.

13. The computer system of claim 11, wherein the read profiling data indicates an average order in which a plurality of guest contexts accessed the plurality of files within the first filesystem image during startup.

14. The computer system of 11, wherein the second filesystem image is a container image (CIM) that stores filesystem metadata and file data separately.

15. The computer system of claim 14, wherein the CIM comprises a plurality of filesystem layers.

16. The computer system of claim 11, wherein the second filesystem image is part of a filesystem image repository accessible by a plurality of host systems.

17. The computer system of claim 11, wherein the second filesystem image is a virtual machine disk image or a container image.

18. The computer system of claim 11, wherein the computer-executable instructions are also executable by the processor system to start a second guest context from the second filesystem image.

19. A computer storage medium that stores computer-executable instructions that are executable by a processor system to at least:
generate read profiling data that corresponds to a first filesystem image, including:
initiating a startup of a guest context;
intercepting a plurality of read input/output (I/O) requests generated by the guest context during the startup of the guest context;
for each read I/O request, identifying a corresponding file within the first filesystem image to which the read I/O request corresponds; and
identifying an order in which the guest context accessed a plurality of files within the first filesystem image during the startup of the guest context based on identifying the corresponding file within the first filesystem image to which each read I/O request corresponds; and
generate a second filesystem image based on the read profiling data, including:
identifying a plurality of data block sets, each data block set comprising one or more data blocks and corresponding to a different file in the plurality of files within the first filesystem image accessed by the guest context during the startup of the guest context;
identifying an ordering of the plurality of data block sets, the ordering corresponding to the order in which the guest context accessed each corresponding file during the startup of the guest context; and
sequentially write each data block set into the second filesystem image using the ordering of the plurality of data block sets.

20. The computer storage medium of claim 19, wherein the second filesystem image is a container image (CIM) that stores filesystem metadata and file data separately.
